(19) United States
(12) Patent Application Publication
(10) Pub. No.: US 2004/0220066 A1
(43) Pub. Date: Nov. 4, 2004

(54) Stripper

(75) Inventor: Edward W. Rutter JR., Pleasanton, CA (US)

Correspondence Address: S. Matthew Cairns, c/o EDWARDS & ANGELL, LLP, P.O. Box 9169, Boston, MA, 02209, US

(73) Assignee: Rohm and Haas Electronic Materials, L.L.C., Marlborough, MA

(21) Appl. No.: 10/835,928

(22) Filed: Apr. 30, 2004

Related U.S. Application Data
(60) Provisional application No. 60/467,471, filed on May 1, 2003.

(51) Int. Cl. H05H 1/00

(52) U.S. Cl. 510/175; 510/504

(57) ABSTRACT

Compositions suitable for removing polymeric material, particularly post-plasma etch polymeric material, from a substrate are provided. These compositions contain one or more quaternary ammonium silicates as the active component. Methods of removing polymeric material using these compositions are also provided.

### BACKGROUND OF THE INVENTION

The present invention relates generally to the field of removal of polymeric materials from a substrate. In particular, the present invention relates to compositions and methods for the removal of polymeric residues from substrates used in the manufacture of electronic devices.

Numerous materials containing polymers are used in the manufacture of electronic devices, such as circuits, disk drives, storage media devices and the like. Such polymeric materials are found in photoresists, solder masks, antireflective coatings, and the like. During manufacture of such electronic devices, the polymeric material is subjected to certain processes and treatment conditions, such as halogen or halide plasma etch, auto-plasma ash processing, reactive ion etching and ion milling, that cause extensive cross-linking of the photoresist polymer and make the removal of such cross-linked polymeric material extremely difficult.

Current processes often utilize positive-type resist materials for lithographically delineating patterns onto a substrate so that the patterns can be subsequently etched or otherwise defined into the substrate material. The resist material is deposited as a film and the desired pattern is defined by exposing the resist film to energetic radiation. Thereafter the exposed regions are subject to a dissolution by a suitable developer. After the pattern has been thus defined in the substrate the resist material must be completely removed from the substrate to avoid adversely affecting or hindering subsequent operations or processing steps.

It is necessary in such a photolithographic process that the photoresist material, following pattern delineation, be evenly and completely removed from all unexposed areas so as to permit further lithographic operations. Even the partial remains of a resist in an area to be further patterned is undesirable. Also, undesired resist residues between patterned lines can have deleterious effects on subsequent processes, such as metallization, or cause undesirable surface states and charges. Resist residues can also cause adhesion failure of barrier/metal layers, reliability issues, electrical isolation (not connected) or electrical connection between electrically isolated areas, (e.g., stringers bridging two metal lines that are subsequently metallized).

Plasma etching, reactive ion etching and ion milling are required as the geometry of features get smaller and pattern density increases. During the plasma etch process, a photoresist film forms a hard to remove organometallic polymeric residue on the side walls of the various features being etched. Furthermore, the photoresist is extensively cross-linked due to the conditions in the etch chamber. Known cleaning processes do not acceptably remove such polymeric residue. For example, acetone or N-methylpyrrolidone is used at extreme conditions, which include high temperature and extended cycle times. Such use conditions are often above the flash point of the solvent which has certain environmental, health and safety issues regarding operator exposure. In addition, productivity and throughput are adversely affected by the extended process cycle times required. Even with such extreme stripping conditions, the devices typically need manual “swabbing”, or brushing, to remove tenacious “rabbit ear”-type polymeric residue from the fine features.

In recent years, the semiconductor manufacturing industry has moved to dry plasma etching processes of metal and oxide layers in order to achieve the desired features with sub-half micron geometry. As a result, the need for photoresist and polymer removers that work effectively without damaging the integrity of fine feature microcircuit lines has drastically increased. Known photoresist removal or stripping formulations that typically contain strong alkaline solutions, organic polar solvents or strong acids and oxidizing agents are no longer applicable for those cross-linked polymers. Typical organic polar solvents used in conventional stripping formulations include pyrrolidones such as N-methylpyrrolidone, N-ethylpyrrolidone, N-hydroxyethylpyrrolidone and N-cyclohexylpyrrolidone; amides including dimethylacetamide or dimethylformamide; phenols and derivatives thereof. Such solvents have been used in combination with amines or other alkaline components that are effective in photoresist stripping. These compositions are not effective in post plasma polymer removal applications as they typically tend to corrode dielectric materials, metal layers or both dielectric materials and metal layers.

Many stripper compositions useful for removing polymeric residue, particularly post-plasma etch residue, contain one or more dissolution enhancing compounds, such as hydroxylamine, tetramethylammonium hydroxide (“TMAH”), ammonium fluoride, and the like. Hydroxylamine-containing stripper compositions have numerous drawbacks including undesirable flammability, explosion hazard, toxicity, volatility, odor, unstability at elevated process temperatures such as up to 80-90° C., and high cost due to handling such a regulated material. TMAH-containing stripper compositions tend to corrode various metal layers. Accordingly, various additional components have been added to such TMAH-containing compositions in an effort to reduce the amount of metal corrosion. Such additional components add to the cost of the stripper compositions and may adversely affect their polymer removing ability. Fluoride-containing stripper compositions may also cause problems by attacking certain silicon-rich layers in an electronic device, such as dielectric layers in an integrated circuit.

Quaternary ammonium silicates are known as corrosion inhibitors. For example, U.S. Pat. No. 5,817,610 (Honda et al.) discloses a composition for removing plasma etching residues containing water, at least one quaternary ammonium hydroxide, and at least one selected corrosion inhibitor. One of the possible corrosion inhibitors is a quaternary ammonium silicate. As this composition can contain a high level of quaternary ammonium hydroxide, metal corrosion can still be a problem.

Accordingly, there is a need for a cleaning composition that effectively removes polymeric material, particularly post-etch polymeric residue, while having reduced tendency to corrode metal.

### SUMMARY OF THE INVENTION

The inventors have found that compositions containing one or more quaternary ammonium silicates as the active cleaning material are very effective in removing polymeric material, particularly post-plasma etch residue, from a substrate. Such compositions remove polymeric material quickly, and show reduced metal corrosion and are less hazardous as compared to conventional post-plasma etch polymer removers.

The present invention provides a composition including: one or more quaternary ammonium silicates and water. Such compositions are effective at removing polymeric material without using additional polymer dissolution enhancing compounds.

Also provided by the present invention is a method of removing polymeric material from a substrate including the step of contacting the polymeric material with the composition described above.

Further provided by the present invention is a method of manufacturing an integrated circuit including the step of contacting post-plasma etch residue on a substrate with the composition described above. Following such contact, the substrate is optionally rinsed and then optionally dried.

### BRIEF DESCRIPTION OF THE DRAWING

FIG. 1A is a scanning electron micrograph (“SEM”) showing, in cross-section, a via in a wafer having post-plasma etch polymer residue.

FIGS. 1B and 1C are SEMS showing, in cross-section, a via in a wafer following contact with a composition of the invention for 60 seconds and 180 seconds, respectively.

### DETAILED DESCRIPTION OF THE INVENTION

As used throughout this specification, the following abbreviations shall have the following meanings unless the context clearly indicates otherwise: ° C.=degrees Centigrade; ppm=parts per million; A=angstrom; % wt=percent by weight; min=minute; ml=milliliter; and DMSO=dimethyl sulfoxide. All percentages are by weight and are based on the total weight of the composition, unless otherwise indicated. All numerical ranges are inclusive and combinable in any order.

The terms “stripping” and “removing” are used interchangeably throughout this specification. Likewise, the terms “stripper” and “remover” are used interchangeably. “Alkyl” refers to linear, branched and cyclic alkyl.

The present invention provides a composition including: one or more quaternary ammonium silicates and water. Such compositions are suitable for use as a cleaner or stripper to remove polymeric material from a substrate. A wide variety of polymeric materials may be removed from a substrate using such composition, including photoresists, polymeric antireflective coatings, inks, dyes, bonding adhesives, and the like. In particular, this composition is effective in removing post-plasma etch polymeric material from an electronic device, such as an integrated circuit.

A wide variety of quaternary ammonium silicates may be used in the present compositions. Exemplary quaternary ammonium silicates include, without limitation, tetraalkyl ammonium silicates, including hydroxy-, alkoxy- or hydroxy-alkoxy-substituted tetraalkyl ammonium silicates. By “hydroxy-, alkoxy- and hydroxy-alkoxy-substituted tetraalkyl ammonium silicates” it is meant that one or more of the hydrogens on one or more of the alkyl groups of the tetraalkyl ammonium silicates are replaced by hydroxyl or alkoxy groups. In general, the alkyl and alkoxy groups contain from 1 to 4 carbon atoms. Suitable quaternary ammonium silicates include, but are not limited to, tetramethyl ammonium silicate, tetraethyl ammonium silicate, methyl triethyl ammonium silicate, trimethyl-2-hydroxyethyl ammonium silicate, methyl tri-2-hydroxyethyl ammonium silicate, trimethyl-3-hydroxypropyl ammonium silicate, trimethyl-3-hydroxybutyl ammonium silicate, trimethyl-4-hydroxybutyl ammonium silicate, triethyl-2-hydroxyethyl ammonium silicate, tripropyl-2-hydroxyethyl ammonium silicate, tributyl-2-hydroxyethyl ammonium silicate, dimethylethyl-2-hydroxyethyl ammonium silicate, dimethyl di(2-hydroxyethyl) ammonium silicate, tetrapropyl ammonium silicate, tetrabutyl ammonium silicate, methyl tripropyl ammonium silicate, methyl tributyl ammonium silicate, ethyl trimethyl ammonium silicate, ethyl tributyl ammonium silicate, dimethyl diethyl ammonium silicate, dimethyl dibutyl ammonium silicate, trimethylbenzyl ammonium silicate and mixtures thereof.

The quaternary ammonium silicates are generally commercially available, such as from Aldrich (Milwaukee, Wis.), or may be prepared by known methods. For example, the quaternary ammonium silicates may be generated in-situ by dissolving any one or more of silicic acid, colloidal silica, fumed silica, tetraalkyl orthosilicates, or any other suitable form of silicon or silica in a composition, typically an aqueous or semi-aqueous composition, containing one or more quaternary ammonium hydroxides. Exemplary tetraalkyl orthosilicates include, without limitation, tetramethyl orthosilicate, tetraethyl orthosilicate, and tetrapropyl orthosilicate. Desired quaternary ammonium silicates are obtain by starting with the corresponding quaternary ammonium hydroxide. For example, tetramethyl ammonium silicate is prepared by reacting tetramethyl ammonium hydroxide with one or more of the silica or silicon sources described above.

Quaternary ammonium silicates having a wide range of mole ratios of quaternary ammonium hydroxide to silicon dioxide may be used. Exemplary mole ratios of quaternary ammonium hydroxide to silicon dioxide include, but are not limited to, 1:0.1 to 1:5. Other exemplary ratios are from 1:0.75 to 1:3, and still other exemplary mole ratios are from 1:1 to 1:2. In particularly useful quaternary ammonium silicates, the moles of silicon dioxide is greater than the moles of quaternary ammonium hydroxide, providing a mole ratio of quaternary ammonium hydroxide to silicon dioxide of <1 to 1, such as from 0.5:1 to 0.75:1.

Any grade of water may be used in the present invention, such as tap, deionized (“DI”), distilled, “Milli-Q” and the like. When used to clean polymeric material from a substrate during the manufacture of an integrated circuit, DI water is typically used in the present compositions. The amount of water used in the present composition may vary over a wide range. An exemplary amount of water is ≧1% wt, based on the total weight of the composition. Other exemplary amounts include, without limitation ≧5% wt, ≧10% wt, ≧15% wt, and ≧20% wt. By way of example, the water may be present in compositions in an amount of 1 to 95% wt.

In addition to the one or more quaternary ammonium silicates and water, the present composition may also contain one or more surfactants, one or more organic solvents, one or more corrosion inhibitors, one or more anti-freeze agents, one or more buffering agents, and the like.

Any suitable surfactant may be used in the present compositions. Exemplary surfactants are nonionic and anionic. Exemplary nonionic surfactants include alkyleneoxide polymers and copolymers, such as, but not limited to, polyethylene glycol, polypropylene glycol, ethyleneoxide (“EO”)/propyleneoxide (“PO”) copolymers, and capped alkyleneoxide polymers. The term “capped alkyleneoxide polymers” refers to alkyleneoxide polymers having one or more terminal alkoxy or aryloxy groups instead of a hydroxyl group. The EO/PO copolymers may be random copolymers or block copolymers. The molecular weights of the surfactants may vary over a wide range, such as from 500 to 500,000 Daltons. Suitable surfactants are generally commercially available from a variety of sources. Exemplary compositions contain such surfactants in an amount of from 10 to 50,000 ppm. Other exemplary compositions contain from 50 to 1000 ppm, and still other exemplary compositions contain from 75 to 100 ppm.

An advantage of the present invention is that additional corrosion inhibitors are not typically needed. However, under certain conditions, such additional corrosion inhibitors may be beneficial. Suitable corrosion inhibitors useful in the present invention include, but are not limited to, hydroxy-substituted aromatic compounds, triazoles, and the like. Exemplary corrosion inhibitors include, without limitation, catechol; (C₁-C₆)alkylcatechol such as methylcatechol, ethylcatechol and tert-butylcatechol; benzotriazole; (C₁-C₁₀)alkylbenzotriazoles; gallic acid; gallic acid esters such as methyl gallate and propyl gallate; and the like. When such corrosion inhibitors are used they are typically present in an amount in the range of 0.01 to 10% wt, based on the total weight of the stripping composition. Other exemplary ranges of corrosion inhibitor are from 0.2 to 5% wt, from 0.5 to 3% wt, and from 1.5 to 2.5% wt.

Any organic solvent that is miscible with water and does not adversely affect the quaternary ammonium silicate may be used in the present compositions. Such organic solvents may aid in the dissolution of the polymeric material removed form the substrate. This may reduce the possibility of particulates (i.e. removed polymeric material) re-depositing on the substrate. Exemplary solvents include polar aprotic solvents such as DMSO and sulfolane; amides such as dimethylformamide and dimethylacetamide; lactones such as γ-butyrolactone; alcohols such as polyhydric alcohols; ketones such as acetone, heptanone, pentanone, cyclohexanone and cyclopentanone; esters such as alkyl acetates, alkyl lactates and glycol ether acetates; ethers; and the like. Such organic solvents are generally commercially available from a variety of sources, such as from Aldrich (Milwaukee, Wis.), and may be used without further purification. Such organic solvents may be used in a wide range of amounts, such as from 1 to 75% wt, based on the total weight of the composition. Other suitable amounts of organic solvent are from 5 to 65% wt, from 5 to 50% wt, and from 5 to 45% wt.

“Polyhydric alcohol” refers to any alcohol having two or more hydroxy groups, such as (C₂-C₂₀)alkanediols, (C₂-C₂₀)alkanetriols, substituted (C₂-C₂₀)alkanediols, substituted (C₂-C₂₀)alkanetriols, and the like. Suitable polyhydric alcohols include, but are not limited to, ethylene glycol, diethylene glycol, triethylene glycol, polyethylene glycol, propylene glycol, dipropylene glycol, tripropylene glycol, polypropylene glycol, 1,3-propanediol, 2-methyl-1,3-propanediol, butanediol, pentanediol, hexanediol, glycerol, and the like. It is preferred that the polyhydric alcohol is 1,3-propanediol, 2-methyl-1,3-propanediol, butanediol or glycerol, and more preferably 1,3-propanediol and 2-methyl-1,3-propanediol.

Exemplary ethers include glycol ethers such as (C₁-C₆)alkyl ethers of (C₂-C₂₀)alkanediols or di(C₁-C₆)alkyl ethers of (C₂-C₂₀)alkanediols. Suitable glycol ethers include, but are not limited to, ethylene glycol monomethyl ether, diethylene glycol monomethyl ether, propylene glycol monomethyl ether, diethylene glycol monobutylether, propylene glycol dimethyl ether, propylene glycol mono-n-butyl ether, dipropylene glycol monomethyl ether, dipropylene glycol dimethyl ether, dipropylene glycol mono-n-butyl ether, tripropylene glycol monomethyl ether, and the like. Suitable glycol ethers are those sold under the DOWANOL tradename such as DOWANOL DPM, DOWANOL TPM, DOWANOL PNB, DOWANOL DB and DOWANOL DPNB (available from Dow Chemical Company, Midland, Mich.).

Any buffering agent may be used in the present compositions provided that it does not adversely affect the polymer removing ability of the composition. The buffering agent is present in an amount sufficient to maintain the pH within a desired range.

The compositions of the present invention may be prepared by combining the one or more quaternary ammonium silicates, water, and one or more optional components in any order. In an embodiment, the quaternary ammonium silicate in water is obtained commercially in either aqueous solution, a suitable organic solvent (e.g. propylene glycol) or a semiaqueous organic solution and the concentration adjusted by dilution with water or organic solvent. Any optional components are then typically added to the composition. In another embodiment, the quaternary ammonium silicate is prepared in water and the concentration adjusted to the desired amount, such as by dilution with water. Any optional components are then typically added.

In an alternate embodiment, the present stripping compositions may be prepared in-situ by combining any one or more of silicic acid, colloidal silica, fumed silica, tetraalkyl orthosilicates, or any other suitable form of silicon or silica in a solvent, typically water, one or more organic solvents or mixtures thereof, along with the quaternary ammonium hydroxide corresponding to the desired quaternary ammonium silicate. Any desired optional components may be added to the composition before, during or after the addition of the silicon or silica source. The quaternary ammonium hydroxide may also be added to the composition before, during or after the addition of the silicon or silica source.

A wide variety of amounts of the one or more quaternary ammonium silicate compounds may be used in the present compositions. Exemplary amounts include, without limitation, from 0.1 to 35% wt, based on the total weight of the composition. Other exemplary amounts include from 1 to 30% wt. Still other exemplary amounts include from 1 to 25% wt, from 5 to 25% wt and from 5 to 15% wt.

In general, the present compositions are alkaline. The pH of the present compositions is typically ≧8, and more typically ≧9. Exemplary compositions have a pH in the range of 8 to 13 and more suitably from 10 to 13.

The present compositions are effective at removing polymeric material from a substrate without using additional polymer dissolution enhancing compounds. In one embodiment, the present compositions are substantially free of additional added polymer dissolution enhancing compounds. As used herein, the term “substantially free” means ≦1% wt. As used herein, the term “polymer dissolution enhancing compounds” refers to polymer dissolution enhancing bases such as hydroxylamine and tetraalkyl ammonium hydroxides, and fluoride ion sources such as ammonium fluoride and ammonium bifluoride. The term “added polymer dissolution enhancing compounds” refers to any polymer dissolution enhancing base or fluoride ion source that is intentionally added to the present compositions in addition to the quaternary ammonium silicates. It will be appreciated by those skilled in the art that an amount of the quaternary ammonium hydroxide compound used to prepare the quaternary ammonium silicate may be present in the stripper composition. Such residual quaternary ammonium hydroxide is not intended to be included within the term “added polymer dissolution enhancing compound” as used herein. In another embodiment, the present compositions are free of additional added polymer dissolution enhancing compounds. In a further embodiment, the present compositions are free of amines, such as primary amines, secondary amines, tertiary amines and alkanolamines.

Polymeric residue on a substrate may be removed by contacting the substrate with a composition of the present invention. The substrate may be contacted with the compositions of the present invention by any known means, such as placing the coated substrate such as a wafer in a hot bath of the stripping composition, like a wet chemical bench, or by putting the wafers in a spray equipment chamber such as in a wafer cleaning apparatus (such as that available from Semitool, Inc, Kalispell, Mont.), followed by a spin, DI water rinse and dry process.

Typically, the polymeric residue removal process of the present invention may be carried out at a wide range of temperatures, such as from room temperature to 100° C. Exemplary temperatures range from 20° to 80° C. Other exemplary temperatures range from 23° to 65° C. The polymer to be removed is typically contacted with the present compositions for a period of time sufficient to at least partially remove the polymer residue. Exemplary times range from 1 to 600 seconds. Other exemplary times range from 5 to 600 seconds, from 5 to 300 seconds, and from 15 to 180 seconds. Other suitable times and temperatures may be used advantageously, depending upon the specific polymeric material to be removed, the particular quaternary ammonium silicate employed and the concentration of the quaternary ammonium silicate in the composition. Such times and temperatures are well within the ability of one skilled in the art.

Thus, the present invention provides a method for manufacturing an electronic device including the steps of contacting the electronic device containing polymeric material to be removed with a composition including one or more quaternary ammonium silicates and water for a period of time sufficient to at least partially remove the polymeric material. Typically, the polymeric material is contacted with the present composition for a period of time sufficient to remove the polymeric material from the substrate. Following the step of contacting the polymeric material with the present composition, the substrate is optionally rinsed, and then optionally dried. In one embodiment, the cleaned substrate may be removed from the present stripper composition and used in subsequent processes without rinsing. Typically, the substrate is rinsed prior to any subsequent processing steps. Suitable electronic devices include, without limitation, integrated circuits, micro-electrical-mechanical (“MEMS”) devices, integrated circuit packages, printed circuit boards, optoelectrical devices such as waveguides, splitters, amplifiers, and multiplexers, and the like.

The compositions of the present invention are extremely effective in removing post plasma etch polymers from different substrates on silicon wafers, flat panel display plates and any other device that has undergone dry plasma etch process.

The following examples are expected to illustrate further various aspects of the present invention, but are not intended to limit the scope of the invention in any aspect.

### EXAMPLE 1

A series of compositions is prepared by combining tetramethyl ammonium silicate (“TMAS”) having a TMAH:SiO₂ molar ratio of 0.5:1 with water. The TMAS is present in an amount of 1, 5 or 25% wt, based on the total weight of the composition.

### EXAMPLE 2

The procedure of Example 1 is repeated except that the TMAS used has a TMAH:SiO₂ molar ratio of 0.75:1.

### EXAMPLE 3

The procedures of Examples 1 and 2 are repeated except that a non-ionic surfactant (an ethyleneoxide (“EO”)/propyleneoxide (“PO”) block copolymer available from BASF under the Pleuronic tradename) is added in an amount of 100 ppm.

### EXAMPLE 4

The procedure of Example 1 is repeated, except that that quaternary ammonium silicate, the ratio of quaternary ammonium hydroxide (“QAH”) to SiO₂, and the use of a surfactant are changed. The various formulations are shown in Table 1. The amount of QAS reported is the percent by weight of QAS in the composition. These compositions are expected to be effective in removing post-plasma etch polymeric material.

TABLE 1

| | | Molar ratio | | | |
|---|---|---|---|---|---|
| | | of QAH: | Amount of | | |
| Example | QAS | SiO₂ | QAS (% wt) | Surfactant (ppm) | Organic Solvent |
| 4-1 | Tetraethyl ammonium | 1:1 | 10 | None | None |
| | silicate | | | | |
| 4-2 | Trimethyl-2-hydroxyethyl | 0.75:1 | 5 | EO/PO block | None |
| | ammonium silicate | | | (100) | |
| 4-3 | Trimethyl-2-hydroxyethyl | 0.75:1 | 5 | EO/PO block | 2-Methyl-1,3- |
| | ammonium silicate | | | (100) | propanediol |
| 4-4 | Methyl tri-2-hydroxyethyl | 0.5:1 | 12 | None | Dipropylene glycol |
| | ammonium silicate | | | | monomethyl ether |
| 4-5 | Methyl tri-2-hydroxyethyl | 0.65:1 | 8 | EO/PO random | None |
| | ammonium silicate | | | (250) | |
| 4-6 | Trimethyl-4-hydroxybutyl | 0.5:1 | 3 | None | Propylene glycol |
| | ammonium silicate | | | | methyl ether |
| | | | | | acetate |
| 4-7 | Triethyl-2-hydroxyethyl | 0.6:1 | 15 | EO/PO block | Ethyl lactate |
| | ammonium silicate | | | (200) | |
| 4-8 | Methyl triethyl ammonium | 0.75:1 | 20 | EO/PO random | None |
| | silicate | | | (500) | |
| 4-9 | Methyl tri-2-hydroxyethyl | 0.75:1 | 22 | Polyethylene | Dipropylene glycol |
| | ammonium silicate | | | glycol (750) | monomethyl ether + |
| | | | | | 2-Methyl-1,3- |
| | | | | | propanediol |

### EXAMPLE 5

A stripping bath is prepared containing 17% wt of tetramethyl ammonium silicate having a mole ratio of TMAH:SiO₂ of 0.5:1 in water. The temperature of the bath is 23° C. A wafer containing vias having post-plasma etch polymer residue is then contacted with the stripping bath. The post-plasma etch polymer residue is removed within 30 seconds.

### EXAMPLE 6

The procedure of Example 5 is repeated except the stripping bath contains 3% wt of tetramethyl ammonium silicate. The post=plasma etch residue is removed within 300 seconds.

### Example 7

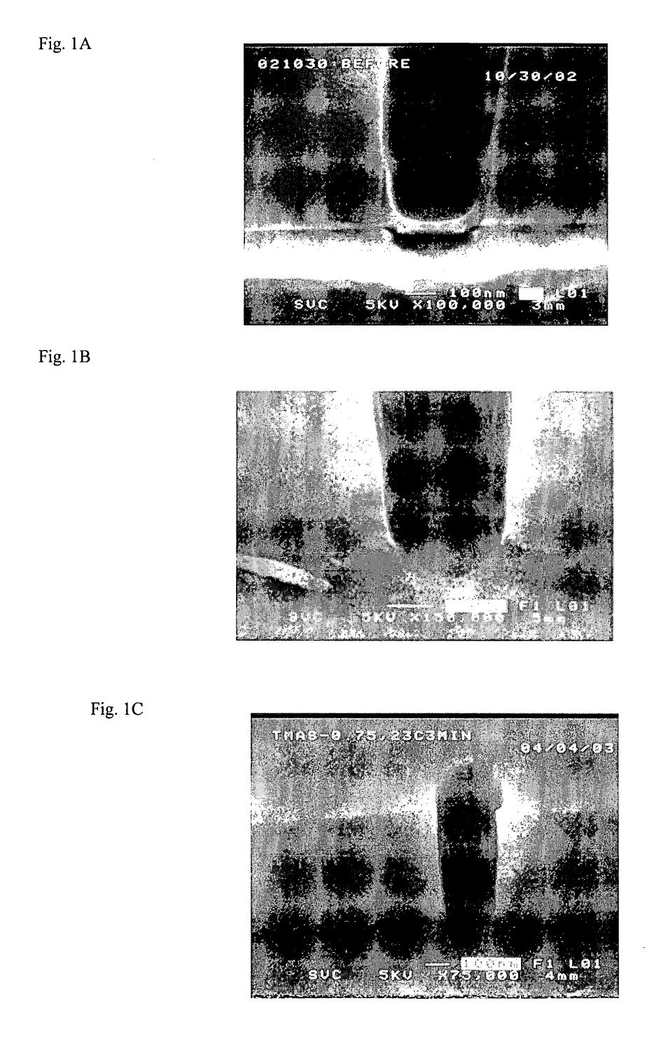

A stripping bath is prepared containing 25% wt of tetramethyl ammonium silicate having a mole ratio of TMAH:SiO₂ of 0.75:1 in water. The bath is heated to 23° C. FIG. 1A is a SEM showing a cross-section of a via before cleaning, the via containing thick sidewall polymer (“SWP”), a post-plasma etch polymer residue, in the bottom of the via. The wafer is then contacted with the stripping bath for either 60, 180 or 300 seconds. Following contact with the stripping bath, the wafer is removed and is then rinsed with DI water for 60 seconds. The results for the 60 and 180 second contact times are shown in FIGS. 1B and 1C. FIG. 1B is a SEM showing a cross-section of a via following contact with the stripping bath for 60 seconds. FIG. 1C is a SEM showing a cross-section of a via following contact with the stripping bath for 180 seconds. SEM analysis of the wafer after 300 seconds of contact time showed no polymer residue and no damage to the via. From these data it is clear that the post-plasma etch polymer residue is completely removed within 60 seconds and that no additional damage results on the patterned substrate either to the dielectric or the metallization upon longer contact times.

What is claimed is:

1. A composition suitable for removing post-plasma etch polymeric material from a substrate comprising one or more quaternary ammonium silicates, and water.

2. The composition of claim 1 further comprising one or more additives chosen from surfactants, corrosion inhibitors, anti-freeze agents, organic solvents, buffering agents and mixtures thereof.

3. The composition of claim 1 wherein one quaternary ammonium silicate is selected from tetramethyl ammonium silicate, tetraethyl ammonium silicate, methyl triethyl ammonium silicate, trimethyl-2-hydroxyethyl ammonium silicate, methyl tri-2-hydroxyethyl ammonium silicate, trimethyl-3-hydroxypropyl ammonium silicate, trimethyl-3-hydroxybutyl ammonium silicate, trimethyl-4-hydroxybutyl ammonium silicate, triethyl-2-hydroxyethyl ammonium silicate, tripropyl-2-hydroxyethyl ammonium silicate, tributyl-2-hydroxyethyl ammonium silicate, dimethylethyl-2-hydroxyethyl ammonium silicate, dimethyl di(2-hydroxyethyl) ammonium silicate, tetrapropyl ammonium silicate, tetrabutyl ammonium silicate, methyl tripropyl ammonium silicate, methyl tributyl ammonium silicate, ethyl trimethyl ammonium silicate, ethyl tributyl ammonium silicate, dimethyl diethyl ammonium silicate, dimethyl dibutyl ammonium silicate, and trimethylbenzyl ammonium silicate.

4. The composition of claim 1 substantially free of additional polymer dissolution enhancing compounds.

5. The composition of claim 1 wherein the quaternary ammonium silicate is present in an amount of from 0.1 to 35% wt.

6. A composition suitable for removing post-plasma etch polymeric material from a substrate consisting essentially of one or more quaternary ammonium silicates, water and optionally one or more additives selected from surfactants, corrosion inhibitors, anti-freeze agents, organic solvents and mixtures thereof.

7. The composition of claim 6 wherein one quaternary ammonium silicate is chosen from tetramethyl ammonium silicate, tetraethyl ammonium silicate, methyl triethyl ammonium silicate, trimethyl-2-hydroxyethyl ammonium silicate, methyl tri-2-hydroxyethyl ammonium silicate, trimethyl-3-hydroxypropyl ammonium silicate, trimethyl-3-hydroxybutyl ammonium silicate, trimethyl-4-hydroxybutyl ammonium silicate, triethyl-2-hydroxyethyl ammonium silicate, tripropyl-2-hydroxyethyl ammonium silicate, tributyl-2-hydroxyethyl ammonium silicate, dimethylethyl-2-hydroxyethyl ammonium silicate, dimethyl di(2-hydroxyethyl) ammonium silicate, tetrapropyl ammonium silicate, tetrabutyl ammonium silicate, methyl tripropyl ammonium silicate, methyl tributyl ammonium silicate, ethyl trimethyl ammonium silicate, ethyl tributyl ammonium silicate, dimethyl diethyl ammonium silicate, dimethyl dibutyl ammonium silicate and trimethylbenzyl ammonium silicate.

8. A method of removing polymeric material from a substrate comprising the step of contacting the polymeric material with the composition of claim 1.

9. A method of removing polymeric material from a substrate comprising the step of contacting the polymeric material with the composition of claim 6.

10. A method of removing polymeric material from a substrate comprising the step of contacting the polymeric material with the composition of claim 2.
